(19) United States
(12) Patent Application Publication
(10) Pub. No.: US 2026/0341750 A1
(43) Pub. Date: Oct. 29, 2026

(54) SYSTEMS AND METHODS OF OPERATING A FUEL CELL HUMIDIFIER

(71) Applicants: CUMMINS INC., Columbus, IN (US); HYDROGENICS CORPORATION, Mississauga (CA)

(72) Inventors: Justin Roberto RIZZI, Oshawa (CA); Timothy C. ERNST, Columbus, IN (US); Sumit TRIPATHI, Columbus, IN (US)

(21) Appl. No.: 19/113,008

(22) PCT Filed: Sep. 25, 2023
(86) PCT No.: PCT/US2023/033579

§ 371 Date: Mar. 19, 2025

Related U.S. Application Data
(60) Provisional application No. 63/411,844, filed on Sep. 30, 2022.

(51) Int. Cl. H01M 8/04119; B60L 50/72; B60L 58/30; H01M 8/04746

(52) U.S. Cl. CPC H01M 8/04141; H01M 8/04753; B60L 50/72; B60L 58/30; H01M 2250/20

(57) ABSTRACT

The present disclosure generally relates to systems and methods for a fuel cell system including a first by-pass valve configured to direct flow of a first portion of a first air stream through a humidifier and a second portion of the first air stream around the humidifier, a second by-pass valve configured to direct the flow of a first portion of a second air stream through a fuel cell stack, and a second portion of the second air stream around the fuel cell stack, and a controller configured to regulate operation of the first by-pass valve and the first by-pass valve. The humidifier is configured to humidify the first portion of the first air stream to form a humidified air stream and the second air stream includes the humidified air stream and the second portion of the first air stream.

### CROSS-REFERENCE TO RELATED APPLICATIONS

This nonprovisional application claims the benefit and priority, under 35 U.S.C. § 119(e) and any other applicable laws or statues, to U.S. Provisional Patent Application Ser. No. 63/411,844 filed on Sep. 30, 2022, the entire disclosure of which is hereby expressly incorporated herein by reference.

### TECHNICAL FIELD

The present disclosure relates to systems and methods of configuring, designing, and/or utilizing a fuel cell humidifier by-pass arrangement.

### BACKGROUND

Vehicles and/or powertrains use fuel cells or fuel cell stacks in fuel cell engines or fuel cell systems for their power needs. A fuel cell or fuel cell stack in the fuel cell engine or fuel cell system may generate electricity in the form of direct current (DC) from electro-chemical reactions that take place in the fuel cell or fuel cell stack. A fuel processor converts fuel into a form usable by the fuel cell or fuel cell stack. The fuel cell engine may be powered by hydrogen or a hydrogen-rich, conventional fuel, such as methanol, gasoline, diesel, or gasified coal.

The humidity in a cathode air stream is required to be controlled to enhance the performance and/or longevity of the fuel cell stack. Humidifiers may be utilized to transfer water vapor from the fuel cell exhaust to the intake cathode air stream. However, over-humidifying the air stream should be regulated. The humidifier includes a wet-side and a dry-side, and by-passing the humidifier on its wet-side a common method used to control the humidity of the cathode air stream entering the fuel cell stack. Furthermore, it may be desirable to dry out the humidifier and/or the fuel cell stack at shutdown to avoid with freezing and biological growth in the fuel cell stack.

The present disclosure provides systems and methods for controlling, regulating, and/or determining the humidity in various air streams entering and/or exiting the fuel cell stack. The present disclosure provides the use of one or more valves to implement a quick transient response when controlling, regulating, and/or determining the humidity in the various air streams depending on the operating conditions of the fuel cell system.

### SUMMARY

Embodiments of the present disclosure are included to meet these and other needs.

In one aspect, described herein, a fuel cell system comprises a first by-pass valve, a second by-pass valve, and a control system. The first by-pass valve is configured to direct flow of a first portion of a first air stream through a humidifier and direct flow of a second portion of the first air stream around the humidifier. The humidifier is configured to humidify the first portion of the first air stream to form a humidified air stream. The second by-pass valve is configured to direct flow of a first portion of a second air stream through a fuel cell stack, and direct flow of a second portion of the second air stream around the fuel cell stack. The second air stream comprises the humidified air stream and the second portion of the first air stream. The control system is configured to regulate operation of the first by-pass valve and the second by-pass valve.

In some embodiments, when the control system is configured to regulate normal operation with full humidification of the fuel cell stack, the first portion of the first air stream may comprise about 100% of the first air stream, and the first portion of a second air stream may comprise about 100% of the second air stream.

In some embodiments, when the control system is configured to regulate normal operation of the fuel cell stack with partial humidification, the first portion of the first air stream may comprise less than about 100% of the first air stream, the second portion of the first air stream may comprise less than about 100% of the first air stream, and the first portion of a second air stream may comprise about 100% of the second air stream.

In some embodiments, when the control system is configured to regulate normal operation with partial fuel cell stack by-pass and partial humidification, the first portion of the first air stream may comprise less than about 100% of the first air stream, the second portion of the first air stream may comprise less than about 100% of the first air stream, the first portion of the second air stream may comprise less than about 100% of the second air stream, the second portion of the second air stream may comprise less than about 100% of the second air stream.

In some embodiments, when the control system is configured to regulate the fuel cell stack dry-out and the fuel cell stack shutdown, the second portion of the first air stream may comprise about 100% of the first air stream, and the first portion of the second air stream may comprise about 100% of the second air stream

In some embodiments, when the control system is configured to regulate the humidifier dry out and the fuel cell stack shutdown, the first portion of the first air stream may comprise about 100% of the first air stream, and the second portion of the second air stream may comprise about 100% of the second air stream.

In some embodiments, system may further comprise a back pressure valve. In some embodiments, the first by-pass valve may be a three (3)-way valve, the second by-pass valve may be a three-way valve, and the back pressure valve may be a two (2)-way valve, and the system may be configured to pass a third air stream through the back pressure valve after the third air stream is passed through the humidifier. In some embodiments, the first by-pass valve may be a three-way valve, the second by-pass valve may be a two-way valve, and the back pressure valve may be a two-way valve, and the system may be configured to pass a third air stream through the back pressure valve after the third air stream is passed through the humidifier.

In some embodiments, the control system may be configured to regulate the operation of the first by-pass valve based on look-ahead information. In some embodiments, the system further may comprise a first humidity sensor to calculate humidity in the first air stream and a second humidity sensor to calculate humidity in the second air stream In some embodiments, the system further may comprise a third humidity sensor to calculate humidity in a third air stream before the third air stream flows through the humidifier into a turbine, wherein the third air stream comprises the first portion of the second air stream and the second portion of the second air stream. In some embodiments, the system may further comprise a fourth humidity sensor to calculate humidity in the third air stream after the third air stream flows through the humidifier, but before the third air stream flows into the turbine.

According to a second aspect, described herein, a method of operating a fuel cell system comprises implementing a control system to determine an operating state of the fuel cell system, flowing a first portion of a first air stream through a humidifier and flowing a second portion of the first air stream around the humidifier, flowing a first portion of a second air stream through a fuel cell stack and flowing a second portion of the second air stream around the fuel cell stack, wherein the second air stream comprises the first portion of the first air stream and the second portion of the first air stream, operating a first valve to determine a first percentage of the first air stream comprised in the first portion of the first air stream and a second percentage of the first air stream comprised in the second portion of the first air stream, and operating a second valve to determine a third percentage of the second air stream comprised in the first portion of the second air stream and a fourth percentage of the second air stream comprised in the second portion of the second air stream. Operating the first valve and the second valve may depend on the operating state of the fuel cell system.

In some embodiments, the method may further comprise using a humidity sensor to calculate a target humidity of the first portion of the second air stream flowing through the fuel cell stack. In some embodiments, the method may further comprise adjusting the first valve based on the target humidity of the first portion of the second air stream flowing through the fuel cell stack. In some embodiments, the method may further comprise adjusting the first valve based on a target flow of the first portion of the second air stream flowing through the fuel cell stack.

In some embodiments, the method may further comprise drying out the humidifier, flowing about 100% of the first flow stream through the humidifier, and flowing about 100% of the second flow stream around the fuel cell stack, and shutting down the fuel cell stack. In some embodiments, the method may further comprise drying out the fuel cell stack, flowing about 100% of the first flow stream around the humidifier and flowing about 100% of the second flow stream through the fuel cell stack, and shutting down the fuel cell stack In some embodiments, the method may further comprise the control system utilizing look-ahead information to control the first valve and the second valve.

### BRIEF DESCRIPTION OF THE DRAWINGS

FIG. 1A is a schematic view of an exemplary fuel cell system including an air delivery system, a hydrogen delivery system, and a fuel cell module including a stack of multiple fuel cells;

FIG. 1B is a cutaway view of an exemplary fuel cell system including an air delivery system, hydrogen delivery systems, and a plurality of fuel cell modules each including multiple fuel cell stacks;

FIG. 1C is a perspective view of an exemplary repeating unit of a fuel cell stack of the fuel cell system of FIG. 1A;

FIG. 1D is a cross-sectional view of an exemplary repeating unit of the fuel cell stack of FIG. 1C;

FIG. 2 is an illustration of one embodiment of a fuel cell system comprising a fuel cell stack, a humidifier, a three-way humidifier by-pass valve, a three-way valve stack isolation/by-pass valve, and a two-way backpressure transfer valve;

FIG. 3 is an illustration of the fuel cell system of FIG. 2 with the fuel cell stack operating with full humidification of a cathode inlet air stream;

FIG. 4 is an illustration of the fuel cell system of FIG. 2 with the fuel cell stack operating with partial humidification of the cathode inlet air stream;

FIG. 5 is an illustration of the fuel cell system of FIG. 2 with the fuel cell stack operating with partial humidification of the cathode inlet air stream and a partial fuel cell by-pass;

FIG. 6 is an illustration of the fuel cell system of FIG. 2 with the fuel cell stack shutting down or with the fuel cell stack not requiring any humidified air;

FIG. 7 is an illustration of the fuel cell system of FIG. 2 with the fuel cell stack not requiring any humidified air and when the humidifier requires drying out;

FIG. 8 is an illustration of another embodiment of a fuel cell system comprising a fuel cell stack, a humidifier, a three-way humidifier by-pass valve, a two-way valve stack isolation/by-pass valve, and a two-way backpressure transfer valve;

FIG. 9A is an illustration of an isolation mode of the three-way humidifier valve;

FIG. 9B is an illustration of an operation mode of the three-way humidifier valve;

FIG. 9C is an illustration of an control mode of the three-way humidifier valve;

FIG. 9D is an illustration of an by-pass mode of the three-way humidifier valve;

FIG. 10 is an illustration of a control system and more than one humidity sensors used to control, regulate, and/or implement the one or more valves in the fuel cell systems described in FIG. 2; and

FIG. 11 is an illustration of one embodiment of the control system used in FIG. 10.

### DETAILED DESCRIPTION

The present disclosure provides systems and methods for controlling, regulating, and/or determining the humidity in various air streams entering and/or exiting the fuel cell stack.

The present disclosure provides systems and methods for controlling, regulating, and/or determining the humidity in various air streams entering and/or exiting the fuel cell stack.

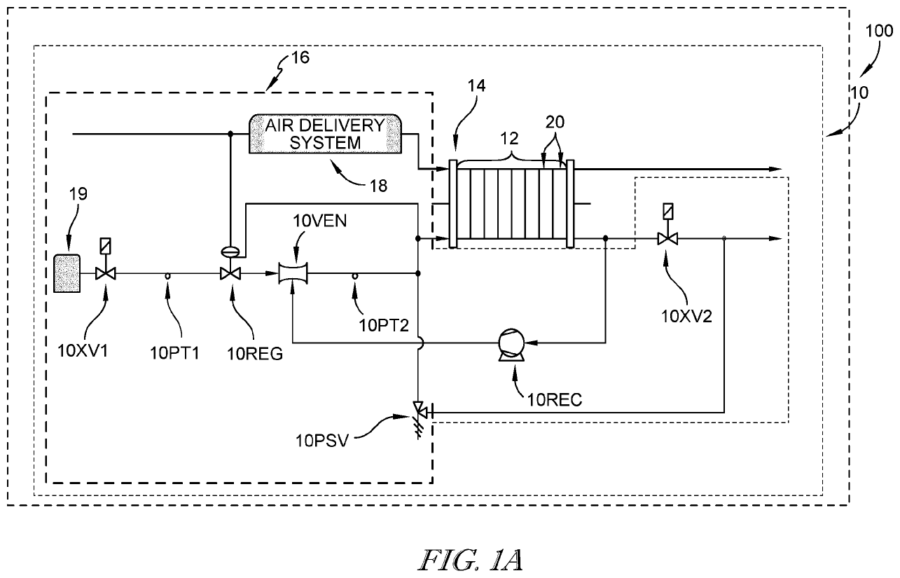

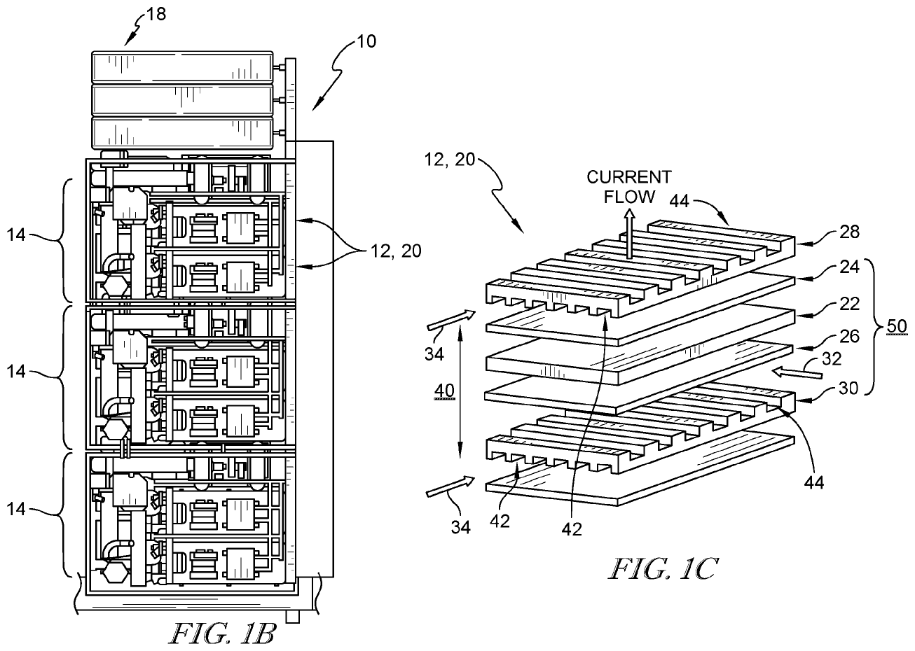

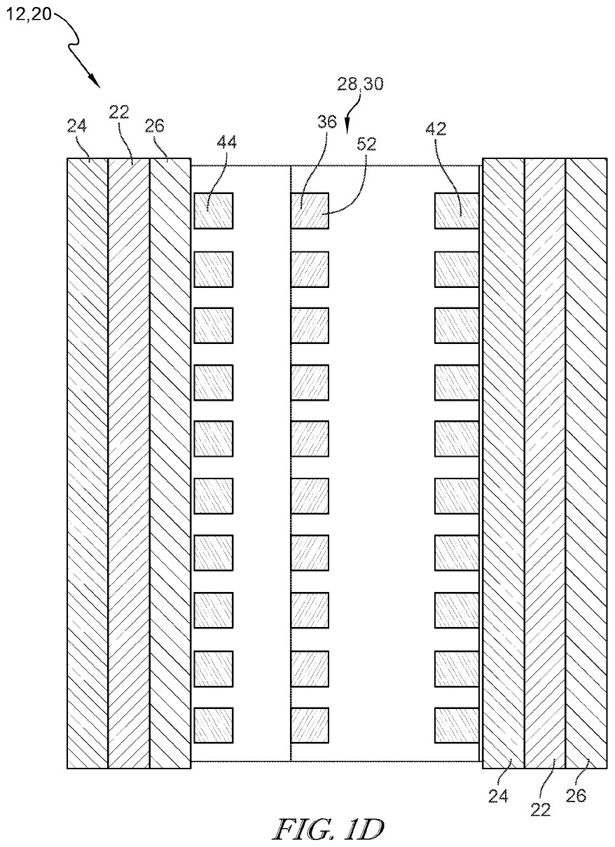

As shown in FIG. 1A, fuel cell systems 10 often include one or more fuel cell stacks 12 (“STK”) or fuel cell modules 14 connected to a balance of plant (BOP) 16, including various components, to support the electrochemical conversion, generation, and/or distribution of electrical power to help meet modern day industrial and commercial needs in an environmentally friendly way. As shown in FIGS. 1B and 1C, fuel cell systems 10 may include fuel cell stacks 12 comprising a plurality of individual fuel cells 20. Each fuel cell stack 12 may house a plurality of fuel cells 20 assembled together in series and/or in parallel. The fuel cell system 10 may include one or more fuel cell modules 14 as shown in FIGS. 1A and 1B.

Each fuel cell module 14 may include a plurality of fuel cell stacks 12 and/or a plurality of fuel cells 20. The fuel cell module 14 may also include a suitable combination of associated structural elements, mechanical systems, hardware, firmware, and/or software that is employed to support the function and operation of the fuel cell module 14. Such items include, without limitation, piping, sensors, regulators, current collectors, seals, and insulators.

The fuel cells 20 in the fuel cell stacks 12 may be stacked together to multiply and increase the voltage output of a single fuel cell stack 12. The number of fuel cell stacks 12 in a fuel cell system 10 can vary depending on the amount of power required to operate the fuel cell system 10 and meet the power need of any load. The number of fuel cells 20 in a fuel cell stack 12 can vary depending on the amount of power required to operate the fuel cell system 10 including the fuel cell stacks 12.

The number of fuel cells 20 in each fuel cell stack 12 or fuel cell system 10 can be any number. For example, the number of fuel cells 20 in each fuel cell stack 12 may range from about 100 fuel cells to about 1000 fuel cells, including any specific number or range of number of fuel cells 20 comprised therein (e.g., about 200 to about 800). In an embodiment, the fuel cell system 10 may include about 20 to about 1000 fuel cells stacks 12, including any specific number or range of number of fuel cell stacks 12 comprised therein (e.g., about 200 to about 800). The fuel cells 20 in the fuel cell stacks 12 within the fuel cell module 14 may be oriented in any direction to optimize the operational efficiency and functionality of the fuel cell system 10.

The fuel cells 20 in the fuel cell stacks 12 may be any type of fuel cell 20. The fuel cell 20 may be a polymer electrolyte membrane or proton exchange membrane (PEM) fuel cell, an anion exchange membrane fuel cell (AEMFC), an alkaline fuel cell (AFC), a molten carbonate fuel cell (MCFC), a direct methanol fuel cell (DMFC), a regenerative fuel cell (RFC), a phosphoric acid fuel cell (PAFC), or a solid oxide fuel cell (SOFC). In an exemplary embodiment, the fuel cells 20 may be a polymer electrolyte membrane or proton exchange membrane (PEM) fuel cell or a solid oxide fuel cell (SOFC).

In an embodiment shown in FIG. 1C, the fuel cell stack 12 includes a plurality of proton exchange membrane (PEM) fuel cells 20. Each fuel cell 20 includes a single membrane electrode assembly (MEA) 22 and a gas diffusion layers (GDL) 24, 26 on either or both sides of the membrane electrode assembly (MEA) 22 (see FIG. 1C). The fuel cell 20 further includes a bipolar plate (BPP) 28, 30 on the external side of each gas diffusion layers (GDL) 24, 26, as shown in FIG. 1C. The above-mentioned components, in particular the bipolar plate 30, the gas diffusion layer (GDL) 26, the membrane electrode assembly (MEA) 22, and the gas diffusion layer (GDL) 24 comprise a single repeating unit 50.

The bipolar plates (BPP) 28, 30 are responsible for the transport of reactants, such as fuel 32 (e.g., hydrogen) or oxidant 34 (e.g., oxygen, air), and cooling fluid 36 (e.g., coolant and/or water) in a fuel cell 20. The bipolar plates (BPP) 28, 30 can uniformly distribute reactants 32, 34 to an active area 40 of each fuel cell 20 through oxidant flow fields 42 and/or fuel flow fields 44 formed on outer surfaces of the bipolar plates (BPP) 28, 30. The active area 40, where the electrochemical reactions occur to generate electrical power produced by the fuel cell 20, is centered, when viewing the stack 12 from a top-down perspective, within the membrane electrode assembly (MEA) 22, the gas diffusion layers (GDL) 24, 26, and the bipolar plate (BPP) 28, 30.

The bipolar plates (BPP) 28, 30 may each be formed to have reactant flow fields 42, 44 formed on opposing outer surfaces of the bipolar plate (BPP) 28, 30, and formed to have coolant flow fields 52 located within the bipolar plate (BPP) 28, 30, as shown in FIG. 1D. For example, the bipolar plate (BPP) 28, 30 can include fuel flow fields 44 for transfer of fuel 32 on one side of the plate 28, 30 for interaction with the gas diffusion layer (GDL) 26, and oxidant flow fields 42 for transfer of oxidant 34 on the second, opposite side of the plate 28, 30 for interaction with the gas diffusion layer (GDL) 24. As shown in FIG. 1D, the bipolar plates (BPP) 28, 30 can further include coolant flow fields 52 formed within the plate (BPP) 28, 30, generally centrally between the opposing outer surfaces of the plate (BPP) 28, 30. The coolant flow fields 52 facilitate the flow of cooling fluid 36 through the bipolar plate (BPP) 28, 30 in order to regulate the temperature of the plate (BPP) 28, 30 materials and the reactants. The bipolar plates (BPP) 28, 30 are compressed against adjacent gas diffusion layers (GDL) 24, 26 to isolate and/or seal one or more reactants 32, 34 within their respective pathways 44, 42 to maintain electrical conductivity, which is required for robust operation of the fuel cell 20 (see FIGS. 1C and 1D).

The fuel cell system 10 described herein, may be used in stationary and/or immovable power system, such as industrial applications and power generation plants. The fuel cell system 10 may also be implemented in conjunction with an air delivery system 18. Additionally, the fuel cell system 10 may also be implemented in conjunction with a hydrogen delivery system and/or a source of hydrogen 19 such as a pressurized tank, including a gaseous pressurized tank, cryogenic liquid storage tank, chemical storage, physical storage, stationary storage, an electrolysis system, or an electrolyzer. In one embodiment, the fuel cell system 10 is connected and/or attached in series or parallel to a hydrogen delivery system and/or a source of hydrogen 19, such as one or more hydrogen delivery systems and/or sources of hydrogen 19 in the BOP 16 (see FIG. 1A). In another embodiment, the fuel cell system 10 is not connected and/or attached in series or parallel to a hydrogen delivery system and/or a source of hydrogen 19.

In some embodiments (see FIG. 1A), the fuel cell system 10 may include an on/off valve 10XV1, a pressure transducer 10PT1, a mechanical regulator 10REG, and a venturi 10VEN arranged in operable communication with each other and downstream of the hydrogen delivery system and/or source of hydrogen 19. The pressure transducer 10PT1 may be arranged between the on/off valve 10XV1 and the mechanical regulator 10REG. In some embodiments, a proportional control valve may be utilized instead of a mechanical regulator 10REG. In some embodiments, a second pressure transducer 10PT2 is arranged downstream of the venturi 10VEN, which is downstream of the mechanical regulator 10REG.

In some embodiments, the fuel cell system 10 may further include a recirculation pump 10REC downstream of the stack 12 and operably connected to the venturi 10VEN. The fuel cell system 10 may also include a further on/off valve 10XV2 downstream of the stack 12, and a pressure transfer valve 10PSV.

The present fuel cell system 10 may also be comprised in mobile applications. In an exemplary embodiment, the fuel cell system 10 is in a vehicle and/or a powertrain 100. A vehicle 100 comprising the present fuel cell system 10 may be an automobile, a pass car, a bus, a truck, a train, a locomotive, an aircraft, a light duty vehicle, a medium duty vehicle, or a heavy-duty vehicle. Type of vehicles 100 can also include, but are not limited to commercial vehicles and engines, trains, trolleys, trams, planes, buses, ships, boats, and other known vehicles, as well as other machinery and/or manufacturing devices, equipment, installations, among others.

The vehicle and/or a powertrain 100 may be used on roadways, highways, railways, airways, and/or waterways. The vehicle 100 may be used in applications including but not limited to off highway transit, bobtails, and/or mining equipment. For example, an exemplary embodiment of mining equipment vehicle 100 is a mining truck or a mine haul truck.

In addition, it may be appreciated by a person of ordinary skill in the art that the fuel cell system 10, fuel cell stack 12, and/or fuel cell 20 described in the present disclosure may be substituted for any electrochemical system, such as an electrolysis system (e.g., an electrolyzer), an electrolyzer stack, and/or an electrolyzer cell (EC), respectively. As such, in some embodiments, the features and aspects described and taught in the present disclosure regarding the fuel cell system 10, stack 12, or cell 20 also relate to an electrolyzer, an electrolyzer stack, and/or an electrolyzer cell (EC). In further embodiments, the features and aspects described or taught in the present disclosure do not relate, and are therefore distinguishable from, those of an electrolyzer, an electrolyzer stack, and/or an electrolyzer cell (EC).

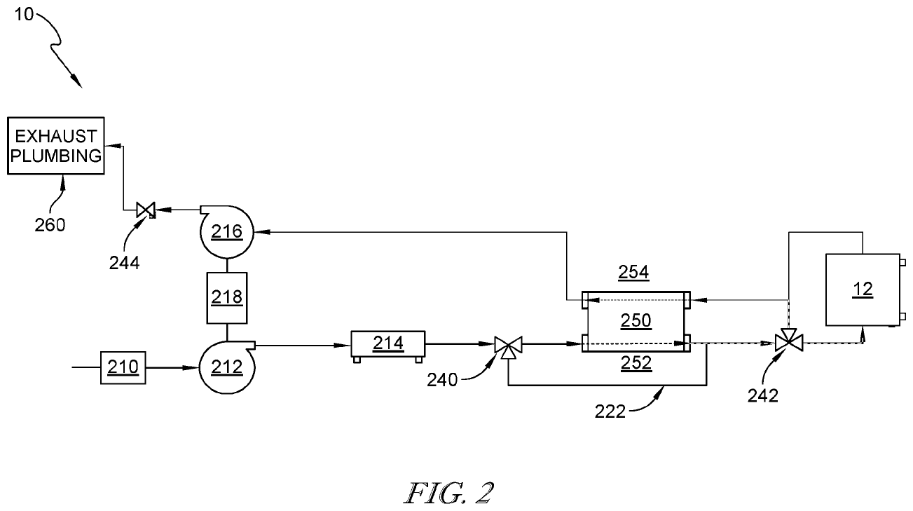

FIG. 2 illustrates one embodiment of the fuel cell system 10 comprising an air filter 210, a compressor 212, a turbine 216, a motor 218, a humidifier 250, and a charge air cooler (CAC) 214 in series or in parallel to the fuel cell stack 12. The humidifier 250 may have a wet-side 254 and a dry-side 252. The fuel cell system 10 may further include one or more valves 240, 242, 244 associated with the humidifier 250. For example, the fuel cell system 10 may include a three-way humidifier by-pass valve 240, a three-way stack isolation or stack by-pass valve 242, and a two-way backpressure transfer valve 244.

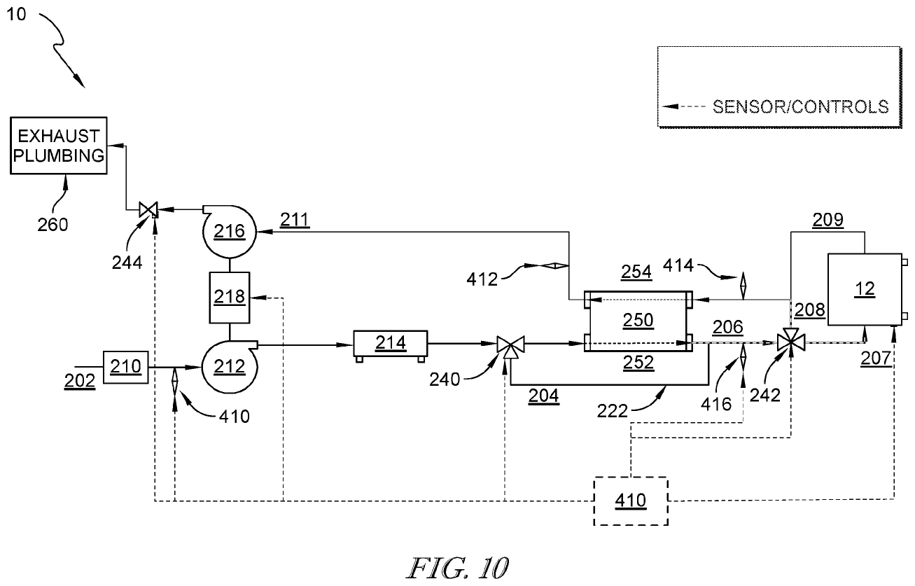

In some embodiments, the fuel cell system 10 may comprise one or more fuel cell stacks 12 and/or one or more fuel cells 20. In some embodiments, there may also be one or more valves, sensors, compressors, regulators, blowers, injectors, ejectors, and/or other devices in series or in parallel with the fuel cell stack 12 and/or other components of the fuel cell system 10. As shown in FIG. 10 and described later, a control system 410 may control, regulate, operate, and/or implement the one or more valves 240, 242, 244 in the fuel cell system 10.

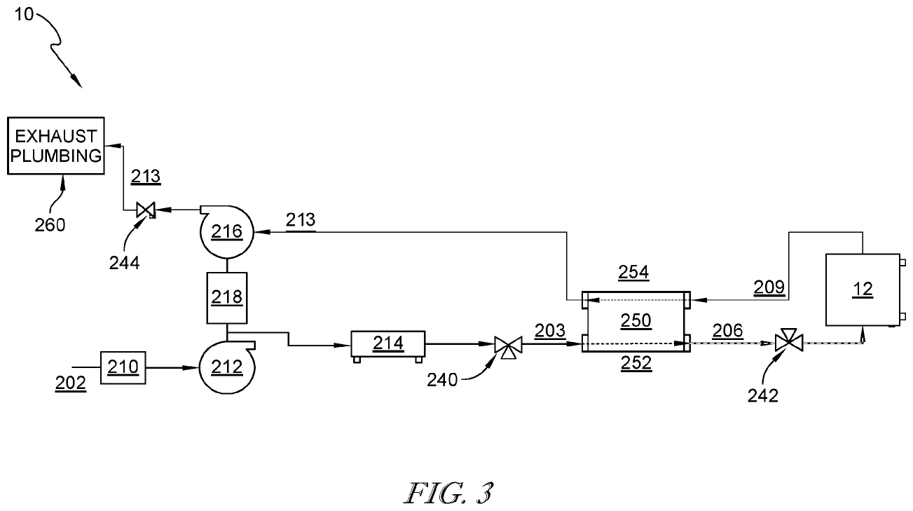

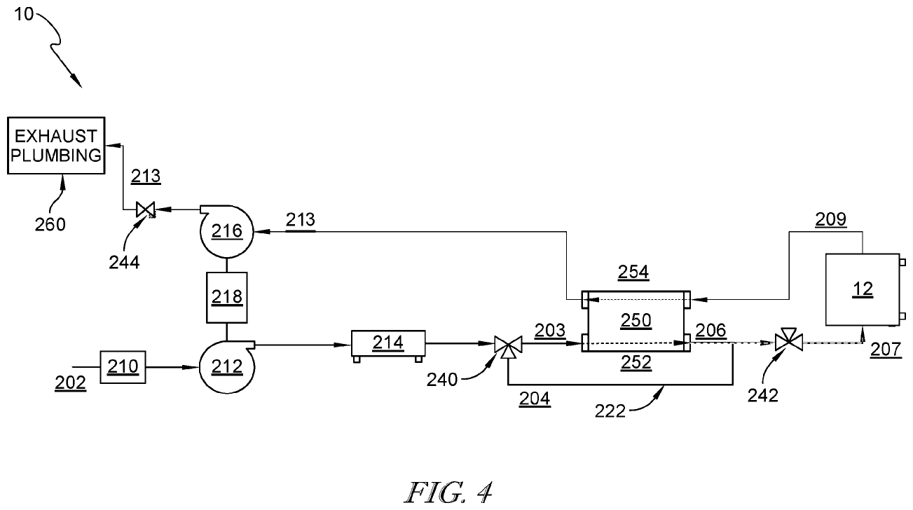

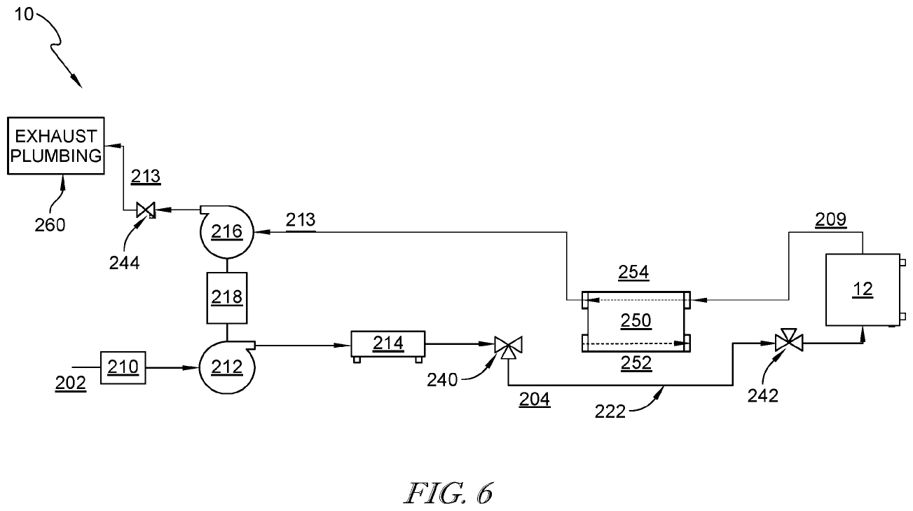

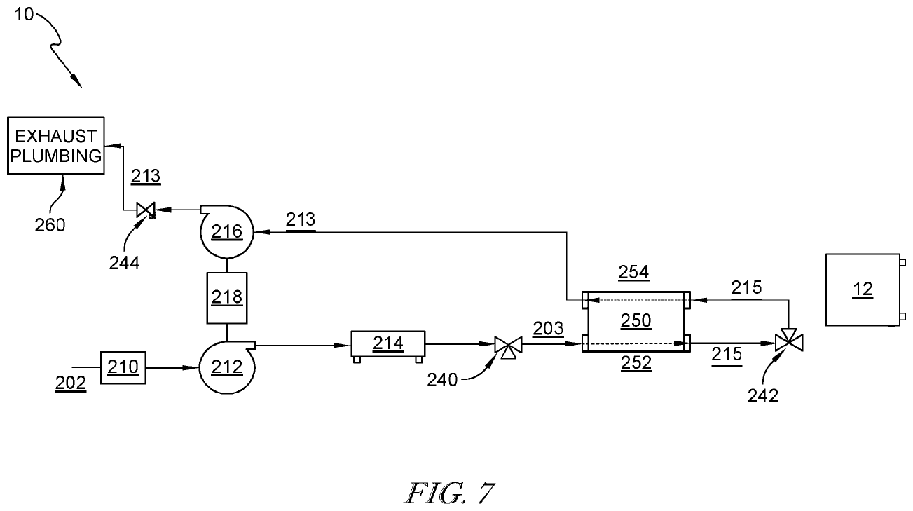

In some embodiments, as illustrated in FIGS. 3 and 7, the fuel cell system 10 may be configured to allow about 100% of a cathode inlet air stream 202 to flow through the humidifier 250. In some embodiments, as illustrated in FIGS. 4, 5, 6 and 8, the fuel cell system 10 may additionally or alternatively include a by-pass air flow 222 around the humidifier 250. In some embodiments, as shown in FIGS. 4, 5, and 8, the by-pass air flow 222 may comprise a portion (e.g., less than about 100%) of the cathode inlet air stream 202. In some embodiments, as shown in FIG. 6, the by-pass air flow 222 may comprise about 100% of the cathode inlet air stream 202. In some embodiments, as shown in FIGS. 3, 4, 5, and 7, the fuel cell system 10 may include the three-way humidifier by-pass valve 240 to direct airflow around the fuel cell stack 12.

The configurations and/or designs illustrated in FIGS. 3-8, allow independent humidity targets to be achieved by the fuel cell stack 12 and the humidifier 250 even when each of them has different optimal operating conditions. The humidity targets of the fuel cell stack 12 and/or the humidifier 250 may be based on a time of operation, a location of operation, and/or an application of operation of the fuel cell system 10. For example the humidity target of the fuel cell stack 12 and the humidifier 250 may define and/or be defined by an optimal humidity value or range for the fuel cell stack 12 and the humidifier 250 under different operating conditions.

The operating conditions of each component and/or the fuel cell stack 12 may be measured, detected, and/or determined during any time period of fuel cell operation, which can particularly include, but is not limited to, during fuel cell stack 12 startup and/or shutdown. For example, the fuel cell stack 12 and/or the humidifier 250 may need to be dried-out and/or dehumidified at shutdown and/or at startup of the fuel cell stack 12. Additionally, the fuel cell stack 12 may need to be isolated and/or protected from ambient or surrounding atmospheric conditions when the fuel cell system 10 it is not operating.

FIG. 3 illustrates normal fuel cell stack 12 operation when a full humidification of the cathode inlet air stream 202 is employed. Normal operation with full humidification of the cathode inlet air stream 202 occurs when the entire cathode inlet air stream 202 is configured to flow through the humidifier 250 before flowing through the fuel cell stack 12. In such configurations, the cathode inlet stream 202 flows through the air filter 210, the compressor 212 and the CAC 214. The cathode inlet stream 202 enters the humidifier 250 as a dry air stream 203 after passing through the three-way humidifier by-pass valve 240. The dry air stream 203 exits the humidifier 250 as a humidified air stream 206. The humidified air stream 206 enters the fuel cell stack 12 after passing through the stack isolation 242.

A humid stack outlet air stream 209 exits the fuel cell stack 12 and passes through the humidifier 250. The humid stack outlet air stream 209 exits the humidifier 250 as an exhaust air steam 213. The exhaust air steam 213 passes through the turbine 216 and exits the backpressure transfer valve 244 into an exhaust plumbing 260. Such a configuration, design, and/or implementation, as shown in FIG. 3, may result in the full humidification of the cathode inlet air stream 202.

Full humidification further indicates that about 90% to about 100% humidification, including any range or specific percentage comprised therein, of an entire volume of the humidified air stream 206 enters the fuel cell stack 12. In one embodiment, when the control system 410 (shown in FIG. 10) determines the fuel cell system 10 to have normal operation with full humidification, about 100% of the cathode inlet air stream 202 may be directed through the humidifier 250. Additionally, in some embodiments, full humidification indicates that about 100% of the humidified air stream 206 may be directed through the fuel cell stack 12.

FIG. 4 illustrates normal fuel cell stack 12 operation when a partial humidification of the cathode inlet air stream 202 is employed. The cathode inlet stream 202 flows through the air filter 210, the compressor 212, and the CAC 214 to enter the humidifier 250 as a dry air stream 203 after passing through the three-way humidifier by-pass valve 240. Normal operation with partial humidification of the cathode inlet air stream 202 indicates that a portion (e.g., less than about 90%) of the cathode inlet stream 202 flows through the humidifier 250 as a dry air stream 203 after passing through the three-way humidifier by-pass valve 240. Additionally, a portion (e.g., less than about 90%) of the cathode inlet stream 202 bypasses the humidifier 250 as a by-pass air stream 204 comprised in the by-pass flow 222.

The dry air stream 203 exits the humidifier 250 as the humidified air stream 206. The by-pass air stream 204 and the humidified air stream 206 combine to enter the fuel cell stack 12 as a stack inlet air stream 207 after passing through the stack isolation 242. Such a configuration, design, and/or implementation as shown in FIG. 4 ensures that a partial volume (e.g., less than 100%) or a portion (e.g., less than about 90%) of the stack inlet air stream 207 is humidified before entering the fuel cell stack 12.

The amount or volume of the humidified air stream 206 comprised in the stack inlet air stream 207 may depend on fuel cell stack 12 requirements. The volume of air that is humidified in the humidifier 250 as the dry air stream 203 passes through the humidifier 250 may range from about 10% to about 100% of the cathode inlet air stream 202 including any percentage or range of percentages comprised therein. For example, the volume of air that is humidified in the humidifier 250 as the dry air stream 203 that passes through the humidifier 250 may be about 10% to about 80%, from about 10% to about 30%, about 30% to about 50%, about 50% to about 80%, or more than 80% (e.g., 100%) of the cathode inlet air stream 202.

When the control system 410 (shown in FIG. 10) determines that the fuel cell system 10 is to have normal operation with partial humidification, less than about 90% of the cathode inlet air stream 202 may be directed through the humidifier 250. Additionally, less than about 100% of the cathode inlet air stream 202 may be directed to bypass the humidifier 250 as the by-pass air stream 204 through the by-pass flow 222 for partial humidification. In one embodiment, more than about 10% and less than about 90%, including any specific or range of percentage comprised therein, of the cathode inlet air stream 202 may be directed to bypass the humidifier 250 as the by-pass air stream 204 through the by-pass flow 222 for partial humidification.

As described previously, the humid stack outlet air stream 209 exits the fuel cell stack 12 and passes through the humidifier 250. The humid stack outlet air stream 209 exits the turbine 216 and the backpressure transfer valve 244 as the exhaust air steam 213 before flowing into the exhaust plumbing 260. The configuration, design, and/or implementation shown in FIG. 4 may be used to optimize performance of the fuel cell system 10.

For example, the stack isolation valve 242 can be implemented to allow a calculated or determined volume of the humidified air stream 206 comprised in the stack inlet air stream 207. This calculation and/or determination is based on the operational requirements of the fuel cell system 10. The volume of the humidified air stream 206 comprised in the stack inlet air stream 207 may range from about 10% to about 100%, including any specific percentage or range comprised therein. For example, the volume of the humidified air stream 206 comprised in the stack inlet air stream 207 may range from about 10% to about 30%, about 30% to about 50%, about 50% to about 80%, or about 80% to about 100% of the stack inlet air stream 207, including any specific or range of percentages comprised therein.

Such a configuration as the presently described embodiment may also be used to optimize fuel cell stack 12 performance by decreasing parasitic costs and/or increasing efficiency. Additionally, relative humidity values in the fuel cell system 10 may also change when the fuel cell system 10 is operating under a transient condition. In one embodiment, the transient condition may comprise operating conditions (load, current, flow rate etc.) of the fuel cell system 10 that fall outside of normal operating parameters specified for steady state conditions. Therefore, the present configuration, design, and/or implementation shown in FIG. 4 may allow for a quick response to changing operating conditions during transient conditions.

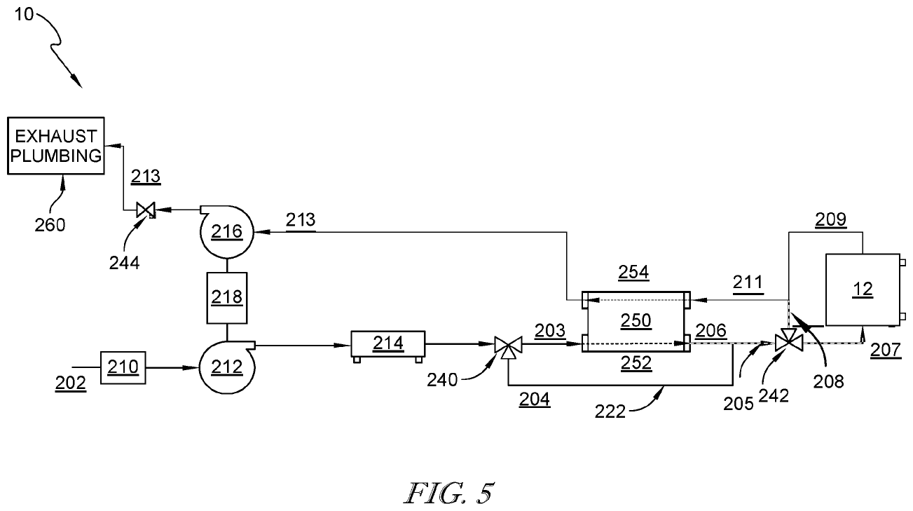

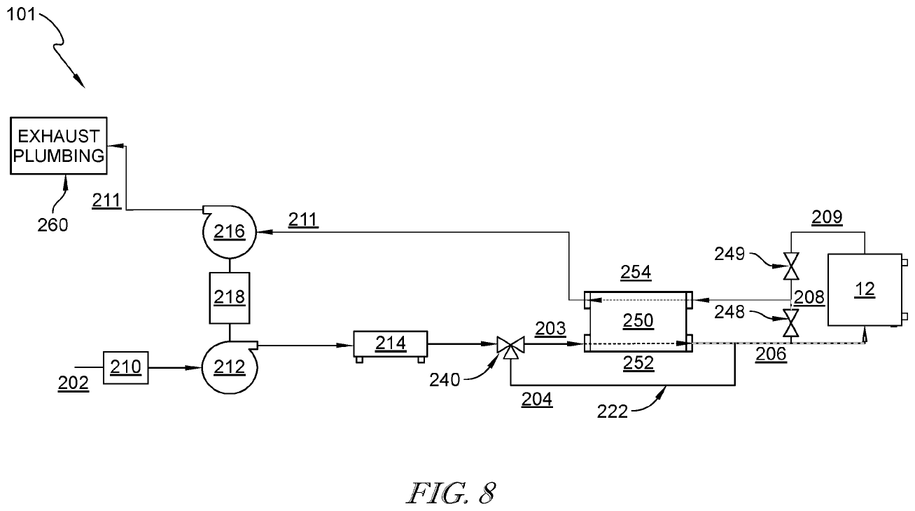

As described in FIGS. 5 and 8, a portion of the cathode inlet air stream 202 may be directed around the fuel cell stack 12, as a stack by-pass air stream 208, when the compressor 212 experiences a surge. A surge may occur when there is no forward flow of gas through the compressor 212 and a reversal of flow occurs. The compressor 212 may experience a surge when the compressor 212 is forced to operate outside of its normal operating range.

For example, the compressor 212 may experience a surge when pressure at an outlet of the compressor 212 exceeds a threshold. The threshold may depend on the operating conditions of the fuel cell system 10 and/or the compressor 212 specifications, such as an operating power, operating load, operating current, operating flow rate, an operating pressure of these components 10, 212, etc. To avoid a surge, the pressure in the stack inlet air stream 207 entering the fuel cell stack 12 can be reduced by opening the stack isolation 242.

FIG. 5 illustrates a normal fuel cell stack 12 operation when partial humidification of the cathode inlet air stream 202 is employed along with a partial fuel cell stack by-pass configuration. As described previously, a portion (e.g., less than about 100%) of the cathode inlet stream 202 may be humidified to form the humidified air stream 206 (e.g., partial humidification). A portion (e.g., less than about 100%) of the cathode inlet stream 202 may be by-passed around the humidifier 250 as the by-pass air stream 204 comprised in the by-pass flow 222. The humidified air stream 206 and the by-pass air stream 204 can be combined to form a partially humidified air stream 205.

The partial fuel cell stack by-pass configuration comprises a portion (e.g., less than about 100%) of the partially humidified air stream 205. That partially humidified air is by-passed around the fuel cell stack 12 as the stack by-pass air stream 208 after passing through the stack isolation 242. The remaining portion (e.g., less than about 100%) of the partially humidified air stream 205 may enter the fuel cell stack 12 as the stack inlet air stream 207.

The volume of air that is by-passed as the stack by-pass air stream 208 may be about 10% to about 100% of the partially humidified air stream 205, including any specific percentage or range of percentages comprised therein. Specifically, the volume of air that is by-passed as the stack by-pass air stream 208 may range from about 10% to about 30%, about 30% to about 50%, about 50% to about 80%, or from about 80% to about 100% of the partially humidified air stream 205, including any specific or range of percentages comprised therein.

When the control system 410 (shown in FIG. 10) determines that the fuel cell system 10 is to have normal operation with partial fuel cell stack by-pass and partial humidification, less than about 90% of the cathode inlet air stream 202 may be directed through the humidifier 250. Additionally, less than about 90% of the cathode inlet air stream 202 may be directed to bypasses the humidifier 250 as the by-pass air stream 204 through the by-pass flow 222 (e.g., partial humidification). Further, less than about 90% of the humidified air stream 206 may be directed through the fuel cell stack 12. Moreover less than about 90% of the humidified air stream 206 may be by-passed around the fuel cell stack 12 as the stack by-pass air stream 208.

As described previously, the humid stack outlet air stream 209 exits the fuel cell stack 12 and passes through the humidifier 250. The stack by-pass air stream 208 may combine with the humid stack outlet air stream 209 to form a humidifier inlet exhaust stream 211. The humidifier inlet exhaust stream 211 exits the humidifier 250, the turbine 216, and the backpressure transfer valve 244 as the exhaust air steam 213 flows into the exhaust plumbing 260. Such a configuration, design, and/or implementation, as shown in FIG. 5, may be implemented or utilized for reasons including but not limited to exhaust dilution, lowering idle power, and/or for compressor surge avoidance.

FIG. 6 illustrates a fuel cell stack dry-out configuration or design that may be implemented when the fuel cell stack 12 is at, in, or near shut down and/or when the fuel cell stack 12 does not require any humidified air. In some embodiments, for example, during shutdown, the fuel cell stack dry-out configuration may comprise the entire cathode inlet stream 202 configured to by-pass the humidifier 250 as the by-pass air stream 204. The by-pass air stream 204 enters the fuel cell stack 12 after passing through the stack isolation valve 242. Therefore, entire cathode inlet stream 202 may enter the fuel cell stack 12 without any humidification at all.

When the control system 410 (shown in FIG. 10) determines the fuel cell system 10 to undergo fuel cell stack 12 shutdown and fuel cell stack 12 dry out, about 100% of the cathode inlet air stream 202 may be directed to bypass the humidifier 250 (e.g., full humidification). The about 100% of the cathode inlet air stream 202 may bypass the humidifier 250 as the by-pass air stream 204 through the by-pass flow 222. Additionally, about 100% of the by-pass air stream 204 may be directed through the stack isolation 242 into the fuel cell stack 12.

As described previously, the humid stack outlet air stream 209 exits the fuel cell stack 12 and passes through the humidifier 250. The humid stack outlet air stream 209 exits the turbine 216 and the backpressure transfer valve 244 as the exhaust air steam 213 into the exhaust plumbing 260. Such a configuration, design, and/or implementation, as shown in FIG. 6, may be implemented or utilized when the fuel cell system 10 is implementing and/or initiating fuel cell stack 12 shutdown procedures.

FIG. 7 illustrates a humidifier dry-out configuration or design that may be implemented when the fuel cell stack 12 does not require any humidified air and/or when the humidifier 250 needs to be dried out. In some embodiments, for example, during shutdown, the humidifier dry-out configuration may comprise the entire cathode inlet stream 202 being passed through the humidifier 250 without undergoing humidification. The humidifier 250 may not be switched on or may not be in a position to function and/or operate in order to add humidity to the cathode inlet air stream 202.

Additionally, in some embodiments, the cathode inlet air stream 202 may be dry and may function to dry out the humidifier 250. The cathode inlet air stream 202 may exit the humidifier 250 as an outlet airstream 215 that is recirculated through the humidifier 250 to form the exhaust air stream 213 that is circulated into the exhaust plumbing 260. Such a configuration, design, and/or implementation, as shown in FIG. 7, may be used when the fuel cell system 10 is implementing and/or initiating humidifier 250 shutdown procedures.

In some embodiments, the humidifier 250 may need to be dried at shutdown. Humidifier 250 shutdown may be implemented to avoid holding water for extended periods of time to prevent, reduce, and/or negate biological or microbial growth and/or to avoid operational difficulties when ambient temperature drops below freezing point. The configuration shown in FIG. 7 allows for independent drying of the humidifier 250 while keeping the fuel cell stack 12 isolated, functional, and/or operational. The configuration shown in FIG. 7 is critical to avoid the fuel cell stack 12 drying and/or drying out during time periods where the humidifier 250 is also drying or drying out.

When the control system 410 (shown in FIG. 10) determines that the fuel cell system 10 undergoes fuel cell stack 12 shutdown and humidifier 250 dry out, about 100% of the cathode inlet air stream 202 may be directed through the humidifier 250 (e.g., full humidification). Additionally, about 100% of the humidified air stream 206 may be by-passed around the fuel cell stack 12 (e.g., full humidification).

FIG. 8 illustrates another embodiment of a fuel cell system 101 comprising the air filter 210, the compressor 212, the turbine 216, the motor 218, the humidifier 250, and/or the CAC 214 in series or in parallel to the fuel cell stack 12. The fuel cell system includes the three-way humidifier by-pass valve 240, a two-way stack isolation/by-pass valve 248, and/or a two-way backpressure transfer valve 249. The combination of the three-way humidifier by-pass valve 240, the two-way stack isolation/by-pass valve 248, and the two-way backpressure transfer valve 249 can be used to achieve the same functionality as the combination of the three-way humidifier by-pass valve 240, the three-way stack isolation valve 242, and the two-way backpressure transfer valve 244. Additionally, operating the fuel cell system 101 with one three-way valve and two two-way valves may be more cost-efficient than operating the fuel cell system 10 with two three-way valves and one two-way valve. The control system (shown in FIG. 10) can determine, regulate, and/or implement the operation of the three-way humidifier by-pass valve 240, the two-way stack isolation/by-pass valve 248, and/or the two-way backpressure transfer valve 249.

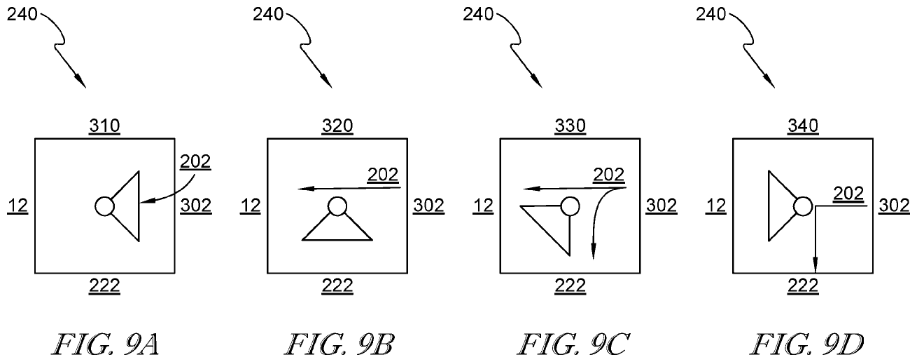

FIGS. 9A-9D illustrate the three-way humidifier valve 240 under different operating conditions. During an isolation mode 310, shown in FIG. 9A, the cathode inlet air stream 202 cannot enter the three-way humidifier valve 240 at an inlet 302. The cathode inlet air stream 202 also cannot pass to either the fuel cell stack 12 or to the by-pass flow 222 around the humidifier 250.

During an operation mode 320, shown in FIG. 9B, the cathode inlet air stream 202 can enter the three-way humidifier valve 240 at the inlet 302 and can pass to the fuel cell stack 12. During the operation mode 320, the cathode inlet air stream 202 cannot be passed to the by-pass flow 222 around the humidifier 250. During a control mode 330, shown in FIG. 9C, the cathode inlet air stream 202 can enter the three-way humidifier valve 240 at the inlet 302.

A portion of the cathode inlet air stream 202 can pass to the fuel cell stack 12 and a portion of the cathode inlet air stream 202 can pass through the by-pass flow 222 around the humidifier 250. During a by-pass mode 340, shown in FIG. 9D, the cathode inlet air stream 202 can enter the three-way humidifier valve 240 at an inlet 302 and can pass through the by-pass flow 222 around the humidifier 250, but cannot pass to the fuel cell stack 12.

As shown in FIG. 10, the control system 410 may communicate with one or more humidity sensors 412, 414, 416, 418 in the fuel cell system 10. The humidity sensors 412, 414, 416, 418 can be used to measure, calculate, and/or determine absolute humidity and/or relative humidity. The control system 410 may control, regulate, determine, and/or implement normal operation and/or a startup of the fuel cell system 10. Similarly, the control system 410 may control, regulate, determine, and/or implement a shutdown of the fuel cell system 10. In some embodiments, the control system 410 may communicate with the one or more humidity sensors 412, 414, 416, 418 in the fuel cell system 110.

In some embodiments, the control system 410 may regulate, control, and/or operate one or more components of the fuel cell system 10, 101 based on the operating state of the fuel cell system 10, 101. The operating state of the fuel cell system 10, 101 may be ascertained to be a normal operation with full humidification, normal operation with partial humidification, partial fuel cell stack by-pass, fuel cell stack dry-out at shutdown, and/or humidifier dry-out at shutdown. The control system 410 may determine the volume of air that is humidified in the humidifier 250 as the dry air stream 203 passes through the humidifier 250. The control system 410 may determine the volume of partially humidified air stream 205 that is by-passed as the stack by-pass air stream 208.

The control system 410 may monitor the humidifier 250 dry-side 252 outlet humidity with the sensor 416. The sensor 416 may monitor the humidified air stream 206 that exits the humidifier 250 The control system 410 may adjust the three-way humidifier by-pass valve 240 to achieve a target humidity in the humidified air stream 206 and/or consequently in the stack inlet air stream 207 entering the fuel cell stack 12.

The control system 410 may monitor, detect, and/or measure other system parameters such as one or more fuel cell stack pressures, temperatures, flowrates, voltage, current, etc., as well as an ambient humidity, a compressor speed, and/or other balance of plant (BOP) parameters, then adjust the target humidity based on the measurements and on the fuel cell system 10 operating mode. The control system 410 may adjust the stack isolation 242 as necessary during operation based on a target flow and a target pressure for an operating mode of the fuel cell system 10. The operating mode of the fuel cell system 10 may comprise a steady state operating mode, a transient operating mode, a shutdown operating mode, a startup operating mode, and/or any other operating mode occurring during fuel cell system 10 operations and functionality.

The control system 410 may control, regulate, detect, determine, and/or implement shutdown of the fuel cell system 10. The control system 410 may implement and/or engage the three-way humidifier by-pass valve 240 to dry out the fuel cell stack 12. The humidity sensor 414 may be used, utilized, and/or implemented at the fuel cell stack 12 outlet to monitor outlet humidity and/or to operate the fuel cell system 10 in the current operating mode (e.g., steady state operating mode, transient operating mode, shutdown, startup, etc.) for a predetermined duration of time. The control system 410 may implement and/or engage the stack isolation 242 to by-pass the fuel cell stack 12 and to dry out the humidifier 250.

Still referring to FIG. 10, the humidity sensor 412 at the humidifier 250 wet-side 254 outlet may be used, utilized, and/or implemented to monitor, detect, and/or measure humidity of the exhaust air stream 213. The humidity sensor 412 may be used, utilized, and/or implemented to operate the fuel cell system 10 in the operating mode (e.g., steady state operating mode, transient operating mode, shutdown, startup etc.) for a predetermined duration of time.

In some embodiments, the control system 410 may set the three-way humidifier valve 240 and/or the three-way stack isolation valve 242 to the isolation mode 310 (shown in FIG. 9A) to close off the path from ambient or surrounding air to the fuel cell stack 12 during shutdown. Additionally or alternatively, the control system 410 may close the backpressure transfer valve 244 to close any path to ambient or surrounding air. The operation of the three-way humidifier valve 240 and/or the three-way stack isolation valve 242 may be based on the utilization of the one or more humidity sensors 412, 414, 416, 418 in the fuel cell system 10.

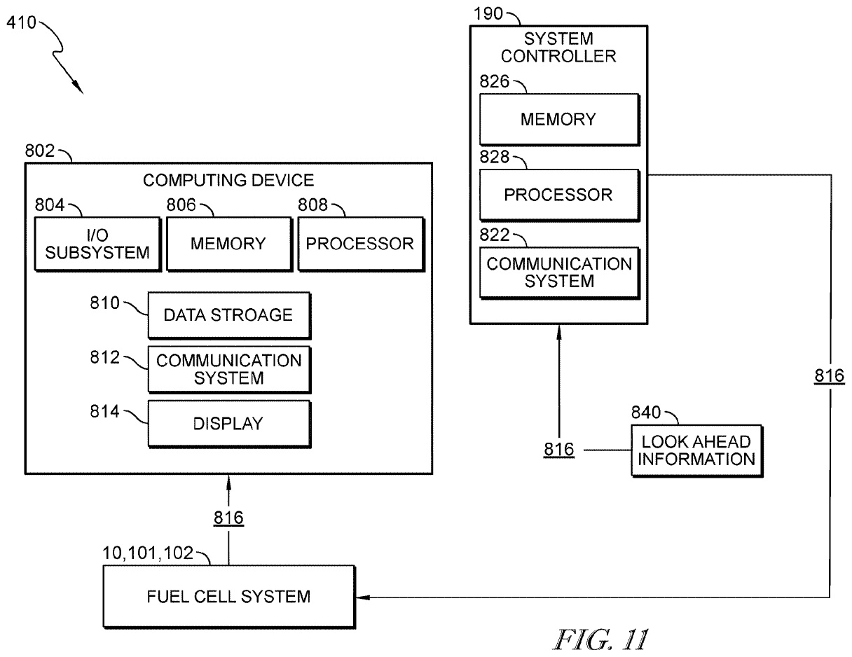

FIG. 11 illustrates one embodiment of the control system 410. The control system 410 may initiate, implement, regulate, and/or control operation of one of more components of the fuel cell system 10, 101. The control system 410 includes a system controller 190. In some embodiments, to facilitate the transfer of data and other network communications across the fuel cell system 10, 101, the system controller 190 may be in communication with a computing device 802 comprising a processor 808 over a network 816. The computing device 802 may be in communication with one or more components of the fuel cell system fuel cell system 10, 101. In some embodiments, the system controller 190 may include a memory 826, a processor 828, and/or a communication subsystem 822.

The computing device 802 may be embodied as any type of computation or computer device capable of performing the functions described herein, including, but not limited to, a server (e.g., stand-alone, rack-mounted, blade, etc.), a network appliance (e.g., physical or virtual), a high-performance computing device, a web appliance, a distributed computing system, a computer, a processor-based system, a multiprocessor system, a smartphone, a tablet computer, a laptop computer, a notebook computer, and a mobile computing device.

The illustrative computing device 802 of FIG. 11 may include one or more of an input/output (FO) subsystem 804, a memory 806, a processor 808, a data storage device 810, a communication subsystem 812, and a display 814 that may be connected to each other, in communication with each other, and/or configured to be connected and/or in communication with each other through wired, wireless and/or power line connections and associated protocols (e.g., Ethernet, InfiniBand®, Bluetooth®, Wi-Fi®, WiMAX, 3G, 4G LTE, 5G, etc.).

The computing device 802 may also include additional and/or alternative components, such as those commonly found in a computer (e.g., various input/output devices). In other embodiments, one or more of the illustrative computing device 802 of components may be incorporated in, or otherwise form a portion of, another component. For example, the memory 806, or portions thereof, may be incorporated in the processor 808.

The processors 808, 828 may be embodied as any type of computational processing tool or equipment capable of performing the functions described herein. For example, the processor 808, 828 may be embodied as a single or multi-core processor(s), digital signal processor, microcontroller, or other processor or processing/controlling circuit. The memory 806, 826 may be embodied as any type of volatile or non-volatile memory or data storage capable of performing the functions described herein.

In operation, the memory 806, 826 may store various data and software used during operation of the computing device 802 and/or system controller 190 such as operating systems, applications, programs, libraries, and drivers. The memory 806 is communicatively coupled to the processor 808 via the I/O subsystem 804, which may be embodied as circuitry and/or components to facilitate input/output operations with the processor 808, the memory 806, and other components of the computing device 802.

For example, the I/O subsystem 804 may be embodied as, or otherwise include, memory controller hubs, input/output control hubs, sensor hubs, host controllers, firmware devices, communication links (i.e., point-to-point links, bus links, wires, cables, light guides, printed circuit board traces, etc.) and/or other components and subsystems to facilitate the input/output operations.

In one embodiment, the memory 806 may be directly coupled to the processor 808, for example via an integrated memory controller hub. Additionally, in some embodiments, the I/O subsystem 804 may form a portion of a system-on-a-chip and be incorporated, along with the processor 808, the memory 806, and/or other components of the computing device 802, on a single integrated circuit chip (not shown).

The memory 826 is communicatively coupled to the processor 828, which may be embodied as circuitry and/or components to facilitate input/output operations with the processor 828, the memory 826, and other components of the system controller 190. In one embodiment, the memory 826 may be directly coupled to the processor 828. In some components the processor 828 may perform the functions of the processor 808. In other embodiments, the system controller may comprise the computing device 802.

The data storage device 810 may be embodied as any type of device or devices configured for short-term or long-term storage of data such as, for example, memory devices and circuits, memory cards, hard disk drives, solid-state drives, or other data storage devices. The computing device 802 also includes the communication subsystem 812, which may be embodied as any communication circuit, device, or collection thereof, capable of enabling communications between the computing device 802 and other remote devices over the computer network 816.

The components of the communication subsystem 812 may be configured to use any one or more communication technologies (e.g., wired, wireless and/or power line communications) and associated protocols (e.g., Ethernet, InfiniBand®, Bluetooth®, Wi-Fi®, WiMAX, 3G, 4G LTE, 5G, etc.) to effect such communication among and between system components and devices.

The system controller 190 may be connected and/or in communication with the computing device 802, the fuel cell system 10, 101, and additional features or components (not shown) of the vehicle 100 comprising fuel cell system 10, 101. These components (190, 802, 812, etc.) may be connected, communicate with each other, and/or configured to be connected or in communication with each over the network 816.

The display 814 of the computing device 802 may be embodied as any type of display capable of displaying digital and/or electronic information, such as a liquid crystal display (LCD), a light emitting diode (LED), a plasma display, a cathode ray tube (CRT), or other type of display device. In some embodiments, the display 814 may be coupled to or otherwise include a touch screen or other input device.

The computing device 802 may also include any number of additional input/output devices, interface devices, hardware accelerators, and/or other peripheral devices. The computing device 802 may be configured into separate subsystems for managing data and coordinating communications throughout the fuel cell system 10, 101. In some embodiments, the computing system 802 may be a part of the system controller 190.

In some embodiments, as shown in FIG. 11, the control system 410 may control, regulate, monitor, and/or operate the different components of the fuel cell system 10, 101 based on look-ahead information 840. For, example, the control system 410 may account for the fact that the fuel cell stack 12 may experience changes in target power output during forthcoming duty cycles. The control system 410 may use knowledge of future duty cycles for pre-setting a humidification target of the fuel cell stack 12.

With look-ahead information 840, the control system 410 may increase or decrease the target humidity of the fuel cell stack 12 ahead of time to allow the fuel cell stack 12 to run at an optimum level throughout the drive cycle. Such a strategy may prevent the fuel cell stack 12 to being reactive and changing the target humidity based on the fuel cell system 10 operating mode.

Additionally, or alternatively, the control system 410 may also apply look-ahead information to the three-way stack isolation 242 to ensure that the compressor 212 is maintained out of any surge region. If a portion of the drive cycle is known to cause compressor surge, the three-way stack isolation 242, can be opened to increase flow rate and speed of the compressor 212 may be adjusted to prevent the occurrence of surge.

A method of regulating or controlling air flow through the humidifier 250 and/or through the fuel cell stack 12 is also described herein. In one embodiment, the method of regulating and/or controlling air flow through the through the humidifier 250 and/or through the fuel cell stack 12 may include the control system 410 monitoring humidity in the humidified air stream 206 that exits the humidifier 250 dry-side 252. The control system 410 may implement, use, and/or utilize the humidity sensor 416 to determine, calculate, measure, and/or assess the humidity in the humidified air stream 206 and/or the humidity in the stack inlet air stream 207.

In some embodiments, the method of regulating or controlling air flow through the humidifier 250 and/or through the fuel cell stack 12 may include the control system 410 determining and/or calculating the target humidity in the stack inlet air stream 207 that enters the fuel cell stack 12. The target humidity in the stack inlet air stream 207 may be based on an operating state of the fuel cell system 10, 101 and/or may be determined or calculated based on the look-ahead information 840.

The operating state of the fuel cell system 10, 101 may be ascertained to be normal operation with full humidification, normal operation with partial humidification, normal operation with partial humidification and/or partial fuel cell stack by-pass, fuel cell stack dry-out at shutdown, and/or humidifier dry-out at shutdown. The control system 410 may monitor other system parameters including but not limited to fuel cell stack pressures, temperatures, flow rates, voltage, current, etc., as well as ambient humidity, compressor speed, and other balance of plant (BOP) parameters to determine or calculate the target humidity required for a give particular operating state.

In some embodiments, the method may include the control system 410 adjusting the three-way humidifier by-pass valve 240 to achieve the target humidity in the stack inlet air stream 207 that enters the fuel cell stack 12. The method may include the control system 410 adjusting the three-way humidifier by-pass valve 240 based on a target flow rate of the stack inlet air stream 207 and/or a target operating pressure of the fuel cell stack 12.

In one embodiment, the method of regulating and/or controlling air flow through the humidifier 250 and/or through the fuel cell stack 12 may include the control system 410 determining when the fuel cell stack 12 is to be shut down. The method may include using the by-pass flow 222 around the humidifier 250 to dry out the fuel cell stack 12 as shown in FIG. 6. The method may comprise drying out the fuel cell stack 12 by flowing about 100% of the cathode inlet air stream 202 around the humidifier 250 as the by-pass air stream 204. The method may further comprise flowing about 100% of the by-pass air stream 204 through the fuel cell stack 12 and shutting down the fuel cell stack 12.

The method may include using, utilizing, and/or implementing the humidity sensor 414 to monitor humidity in the stack outlet air stream 209. The method may include the control system 410 operating the fuel cell system 10, 101 by utilizing the by-pass flow 222 around the humidifier 250 for a predetermined fuel cell stack dry-out duration of time. The predetermined fuel cell stack dry-out duration of time may be based on look-up tables, computational models, experimental models, and/or other variables.

The method may further include the cathode inlet air stream 202 by-passing the fuel cell stack 12 to dry-out the humidifier 250 as shown in FIG. 7. The method may include using, utilizing, and/or implementing the humidity sensor 412 to monitor humidity at the humidifier 250 wet-side 254 outlet. The method may include the control system 410 operating the fuel cell system 10, 101 by-passing the fuel cell stack 12 for a predetermined humidifier dry-out duration of time. The predetermined humidifier dry-out duration of time may be based on look-up tables, computational models, experimental models, and/or other variables. The method may comprise drying out the humidifier 250 by flowing about 100% of the cathode inlet air stream 202 through the humidifier 250, by flowing about 100% of the outlet air stream 215 around the fuel cell stack 12, and shutting down the fuel cell stack 12.

The method may include the control system 410 using, utilizing, and/or implementing the three-way humidifier valve 240 and/or the three-way stack isolation 242 to close off any path from ambient air to the fuel cell stack 12 during shutdown. As shown in FIG. 10, the method may include the control system 410 using, utilizing, and/or implementing look-ahead information 840 to control, regulate, monitor, and/or operate one or more components of the fuel cell system 10, 101.

The following described aspects of the present invention are contemplated and non-limiting:

A first aspect of the present invention relates to a fuel cell system. The fuel cell system comprises a first by-pass valve, a second by-pass valve, and a control system. The first by-pass valve is configured to direct flow of a first portion of a first air stream through a humidifier and direct flow of a second portion of the first air stream around the humidifier. The humidifier is configured to humidify the first portion of the first air stream to form a humidified air stream. The second by-pass valve is configured to direct flow of a first portion of a second air stream through a fuel cell stack, and direct flow of a second portion of the second air stream around the fuel cell stack. The second air stream comprises the humidified air stream and the second portion of the first air stream. The control system is configured to regulate operation of the first by-pass valve and the second by-pass valve.

A second aspect of the present invention relates to a method of operating a fuel cell system. The method comprises implementing a control system to determine an operating state of the fuel cell system, flowing a first portion of a first air stream through a humidifier and flowing a second portion of the first air stream around the humidifier, flowing a first portion of a second air stream through a fuel cell stack and flowing a second portion of the second air stream around the fuel cell stack, wherein the second air stream comprises the first portion of the first air stream and the second portion of the first air stream, operating a first valve to determine a first percentage of the first air stream comprised in the first portion of the first air stream and a second percentage of the first air stream comprised in the second portion of the first air stream, and operating a second valve to determine a third percentage of the second air stream comprised in the first portion of the second air stream and a fourth percentage of the second air stream comprised in the second portion of the second air stream. Operating the first valve and the second valve depends on the operating state of the fuel cell system.

In the first aspect of the present invention, when the control system is configured to regulate normal operation with full humidification of the fuel cell stack, the first portion of the first air stream comprises about 100% of the first air stream, and the first portion of a second air stream comprises about 100% of the second air stream.

In the first aspect of the present invention, when the control system is configured to regulate normal operation of the fuel cell stack with partial humidification, the first portion of the first air stream comprises less than about 100% of the first air stream, the second portion of the first air stream comprises less than about 100% of the first air stream, and the first portion of a second air stream comprises about 100% of the second air stream.

In the first aspect of the present invention, when the control system is configured to regulate normal operation with partial fuel cell stack by-pass and partial humidification, the first portion of the first air stream comprises less than about 100% of the first air stream, the second portion of the first air stream comprises less than about 100% of the first air stream, the first portion of the second air stream comprises less than about 100% of the second air stream, the second portion of the second air stream comprises less than about 100% of the second air stream.

In the first aspect of the present invention, when the control system is configured to regulate the fuel cell stack dry-out and the fuel cell stack shutdown, the second portion of the first air stream comprises about 100% of the first air stream, and the first portion of the second air stream comprises about 100% of the second air stream

In the first aspect of the present invention, when the control system is configured to regulate the humidifier dry out and the fuel cell stack shutdown, the first portion of the first air stream comprises about 100% of the first air stream, and the second portion of the second air stream comprises about 100% of the second air stream.

In the first aspect of the present invention, system further comprises a back pressure valve. In the first aspect of the present invention, the first by-pass valve is a three-way valve, the second by-pass valve is a three-way valve, and the back pressure valve is a two-way valve, and the system is configured to pass a third air stream through the back pressure valve after the third air stream is passed through the humidifier. In the first aspect of the present invention, the first by-pass valve is a three-way valve, the second by-pass valve is a two-way valve, and the back pressure valve is a two-way valve, and the system is configured to pass a third air stream through the back pressure valve after the third air stream is passed through the humidifier.

In the first aspect of the present invention, the control system is configured to regulate the operation of the first by-pass valve based on look-ahead information. In the first aspect of the present invention, the system further comprises a first humidity sensor to calculate humidity in the first air stream and a second humidity sensor to calculate humidity in the second air stream. In the first aspect of the present invention, the system further comprises a third humidity sensor to calculate humidity in a third air stream before the third air stream flows through the humidifier into a turbine, wherein the third air stream comprises the first portion of the second air stream and the second portion of the second air stream. In the first aspect of the present invention, the system further comprises a fourth humidity sensor to calculate humidity in the third air stream after the third air stream flows through the humidifier, but before the third air stream flows into the turbine.

In the second aspect of the present invention, the method further comprises using a humidity sensor to calculate a target humidity of the first portion of the second air stream flowing through the fuel cell stack. In the second aspect of the present invention, the method further comprises adjusting the first valve based on the target humidity of the first portion of the second air stream flowing through the fuel cell stack. In the second aspect of the present invention, the method further comprises adjusting the first valve based on a target flow of the first portion of the second air stream flowing through the fuel cell stack.

In the second aspect of the present invention, the method further comprises drying out the humidifier, flowing about 100% of the first flow stream through the humidifier, and flowing about 100% of the second flow stream around the fuel cell stack, and shutting down the fuel cell stack. In the second aspect of the present invention, the method further comprises drying out the fuel cell stack, flowing about 100% of the first flow stream around the humidifier and flowing about 100% of the second flow stream through the fuel cell stack, and shutting down the fuel cell stack. In the second aspect of the present invention, the method further comprises the control system utilizing look-ahead information to control the first valve and the second valve.

The features illustrated or described in connection with one exemplary embodiment or aspect may be combined with any other feature or element of any other embodiment or aspect described herein. Such modifications and variations are intended to be included within the scope of the present disclosure. Further, a person skilled in the art will recognize that terms commonly known to those skilled in the art may be used interchangeably herein.

The above embodiments and aspects are described in sufficient detail to enable those skilled in the art to practice what is claimed and it is to be understood that other embodiments may be utilized and that logical, mechanical, and electrical changes may be made without departing from the spirit and scope of the claims. The detailed description is, therefore, not to be taken in a limiting sense.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Specified numerical ranges of units, measurements, and/or values include, consist essentially or, or consist of all the numerical values, units, measurements, and/or ranges including or within those ranges and/or endpoints, whether those numerical values, units, measurements, and/or ranges are explicitly specified in the present disclosure or not.

Unless defined otherwise, technical and scientific terms used herein have the same meaning as is commonly understood by one of ordinary skill in the art to which this disclosure belongs. The terms “first,” “second,” “third,” and the like, as used herein do not denote any order or importance, but rather are used to distinguish one element from another. The term “or” and “and/or” is meant to be inclusive and mean either or all of the listed items. In addition, the terms “connected” and “coupled” are not restricted to physical or mechanical connections or couplings, and can include electrical connections or couplings, whether direct or indirect.

Moreover, unless explicitly stated to the contrary, embodiments “comprising,” “including,” or “having” an element or a plurality of elements having a particular property may include additional such elements not having that property. The term “comprising” or “comprises” refers to a composition, compound, formulation, or method that is inclusive and does not exclude additional elements, components, and/or method steps. The term “comprising” also refers to a composition, compound, formulation, or method embodiment of the present disclosure that is inclusive and does not exclude additional elements, components, or method steps. The phrase “consisting of’ or “consists of’ refers to a compound, composition, formulation, or method that excludes the presence of any additional elements, components, or method steps.

The term “consisting of’ also refers to a compound, composition, formulation, or method of the present disclosure that excludes the presence of any additional elements, components, or method steps. The phrase “consisting essentially of’ or “consists essentially of’ refers to a composition, compound, formulation, or method that is inclusive of additional elements, components, or method steps that do not materially affect the characteristic(s) of the composition, compound, formulation, or method. The phrase “consisting essentially of’ also refers to a composition, compound, formulation, or method of the present disclosure that is inclusive of additional elements, components, or method steps that do not materially affect the characteristic(s) of the composition, compound, formulation, or method steps.

Approximating language, as used herein throughout the specification and claims, may be applied to modify any quantitative representation that could permissibly vary without resulting in a change in the basic function to which it is related. Accordingly, a value modified by a term or terms, such as “about,” and “substantially” is not to be limited to the precise value specified. In some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

It is to be understood that the above description is intended to be illustrative, and not restrictive. For example, the above-described embodiments (and/or aspects thereof) may be used individually, together, or in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A fuel cell system, comprising:
a first by-pass valve configured to direct a flow of a first portion of a first air stream through a humidifier, and to direct a flow of a second portion of the first air stream around the humidifier, wherein the humidifier is configured to humidify the first portion of the first air stream to form a humidified air stream,
a second by-pass valve configured to direct the flow of a first portion of a second air stream through a fuel cell stack, and to direct a flow of a second portion of the second air stream around the fuel cell stack, wherein the second air stream comprises the humidified air stream and the second portion of the first air stream, and
a control system configured to regulate operation of the first by-pass valve and the second by-pass valve.

2. The system of claim 1, wherein the control system is configured to regulate a normal operation of the fuel cell stack with full humidification, when the first portion of the first air stream comprises about 100% of the first air stream, and the first portion of the second air stream comprises about 100% of the second air stream.

3. The system of claim 1, wherein the control system is configured to regulate a normal operation of the fuel cell stack with partial humidification, when the first portion of the first air stream comprises less than about 100% of the first air stream, the second portion of the first air stream comprises less than about 100% of the first air stream, and the first portion of the second air stream comprises about 100% of the second air stream.

4. The system of claim 1, wherein the control system is configured to regulate a normal operation with a partial fuel cell stack by-pass and partial humidification, when the first portion of the first air stream comprises less than about 100% of the first air stream, the second portion of the first air stream comprises less than about 100% of the first air stream, the first portion of the second air stream comprises less than about 100% of the second air stream, and the second portion of the second air stream comprises less than about 100% of the second air stream.

5. The system of claim 1, wherein the control system is configured to regulate the fuel cell stack dry-out and the fuel cell stack shutdown, when the second portion of the first air stream comprises about 100% of the first air stream and the first portion of the second air stream comprises about 100% of the second air stream.

6. The system of claim 1, wherein the control system is configured to regulate the humidifier dry out and the fuel cell stack shutdown, the first portion of the first air stream comprises about 100% of the first air stream and the second portion of the second air stream comprises about 100% of the second air stream.

7. The system of claim 1, wherein the system further comprises a back pressure valve.

8. The system of claim 7, wherein the first by-pass valve is a three-way valve, the second by-pass valve is a three-way valve, and the back pressure valve is a two-way valve, and the system is configured to pass a third air stream through the back pressure valve after the third air stream is passed through the humidifier.

9. The system of claim 7, wherein the first by-pass valve is a three-way valve, the second by-pass valve is a two-way valve, and the back pressure valve is a two-way valve, and the system is configured to pass a third air stream through the back pressure valve after the third air stream is passed through the humidifier.

10. The system of claim 1, wherein the control system is configured to regulate the operation of the first by-pass valve based on look-ahead information.

11. The system of claim 1, wherein the system further comprises a first humidity sensor configured to calculate a humidity of the first air stream and a second humidity sensor configured to calculate humidity in the second air stream.

12. The system of claim 11, wherein the system further comprises a third humidity sensor configured to calculate a humidity of a third air stream before the third air stream flows through the humidifier into a turbine, wherein the third air stream comprises the first portion of the second air stream and the second portion of the second air stream.

13. The system of claim 12, wherein the system further comprises a fourth humidity sensor configured to calculate humidity in the third air stream after the third air stream flows through the humidifier and before the third air stream flows into the turbine.

14. A method of operating a fuel cell system comprising:
implementing a control system to determine an operating state of the fuel cell system,
flowing a first portion of a first air stream through a humidifier and flowing a second portion of the first air stream around the humidifier,
flowing a first portion of a second air stream through a fuel cell stack and flowing a second portion of the second air stream around the fuel cell stack, wherein the second air stream comprises the first portion of the first air stream and the second portion of the first air stream,
operating a first valve to detect a first percentage of the first air stream comprised in the first portion of the first air stream and a second percentage of the first air stream comprised in the second portion of the first air stream, and
operating a second valve to determine a third percentage of the second air stream comprised in the first portion of the second air stream and a fourth percentage of the second air stream comprised in the second portion of the second air stream,
wherein operating the first valve and the second valve depends on the operating state of the fuel cell system.

15. The method of claim 14, further comprising calculating a target humidity of the first portion of the second air stream flowing through the fuel cell stack using a humidity sensor.

16. The method of claim 15, further comprising adjusting the first valve based on the target humidity of the first portion of the second air stream flowing through the fuel cell stack.

17. The method of claim 15, further comprising adjusting the first valve based on a target flow of the first portion of the second air stream flowing through the fuel cell stack.

18. The method of claim 14, further comprising drying out the humidifier, flowing about 100% of the first flow stream through the humidifier, flowing about 100% of the second flow stream around the fuel cell stack, and shutting down the fuel cell stack.

19. The method of claim 14, further comprising drying out the fuel cell stack, flowing about 100% of the first flow stream around the humidifier, flowing about 100% of the second flow stream through the fuel cell stack, and shutting down the fuel cell stack.

20. The method of claim 14, further comprising controlling, by the control system, the first valve and the second valve using look-ahead information.
